(19) United States
(12) Patent Application Publication
(10) Pub. No.: US 2011/0060607 A1
(43) Pub. Date: Mar. 10, 2011

(54) HEALTH CARE INFORMATION SYSTEMS

(76) Inventors: Carl Kesselman, Santa Monica, CA (US); Stephan G. Erberich, Westlake Village, CA (US); Frank Siebenlist, Los Gatos, CA (US); Xun Sun, Great Falls, VA (US); Karl Czajkowski, Marina del Rey, CA (US); Laura Pearlman, Pasadena, CA (US); John Wroclawski, Venice, CA (US); John Hickey, Playa del Rey, CA (US)

(21) Appl. No.: 12/845,599

(22) Filed: Jul. 28, 2010

Related U.S. Application Data
(63) Continuation-in-part of application No. 12/784,329, filed on May 20, 2010.
(60) Provisional application No. 61/180,074, filed on May 20, 2009.
(60) Provisional application No. 61/221,410, filed on Jun. 29, 2009.

(51) Int. Cl. G06Q 50/00; G06Q 10/00

(52) U.S. Cl. 705/3; 705/2

(57) ABSTRACT

A health care information provider system may provide information about health care objects managed by a health care provider. A name generating system may generate an object name for each of the health care objects which may include provider information indicative of the identity of the health care provider which manages the health care object, and object information indicative of the identity of the health care object. The object information may be devoid of any personal health information, even in a form which can be decrypted by a decryption key.

A computer system appliance may protect the privacy of medical record information stored in a computer information storage system and may include a medical record distribution compartment, a medical record acquisition compartment, and a security compartment. The medical record distribution compartment and the medical record acquisition compartment may be configured to communicate with one another only thought the security compartment.

### CROSS-REFERENCE TO RELATED APPLICATIONS

This application is a continuation-in-part of U.S. patent application Ser. No. 12/784,329 entitled “HEALTH CARE INFORMATION SYSTEMS USING OBJECT IDENTIFIERS DEVOID OF PERSONAL INFORMATION,” filed May 20, 2010, attorney docket number 028080-0572, which was based upon and claimed priority to U.S. provisional patent application 61/180,074, entitled “HEALTH OBJECT IDENTIFIER,” filed May 20, 2009, attorney docket number 028080-0471, and to U.S. provisional patent application 61/221,410, entitled “HIPAA COMPLIANT MEDICAL RECORD EXCHANGE APPLIANCE CHI APPLIANCE,” filed Jun. 29, 2009, attorney docket number 028080-0481. The entire content of all of these applications is incorporated herein by reference.

### BACKGROUND

### Technical Field

This disclosure relates to health care information systems, including systems which communicate health care information between different health care providers.

This disclosure also relates to protecting the privacy of medical record information, including compliance with the Health Insurance Portability and Accountability Act (HIPAA).

### Description of Related Art

Health care information often needs to be exchanged between different institutions, such as between different health care providers. However, there are numerous laws which protect the security and privacy of much of this information. One example is the Health Insurance Portability and Accountability Act of 1966 (HIPAA). This act includes administrative simplification provisions which require national standards for electronic health care transactions and national identifiers for providers, health insurance plans, and employers. The administration simplification provisions also impose stringent security and privacy requirements on health care data.

Unfortunately, it can be difficult to comply with all of these laws while exchanging needed health care information. This can make the exchange of such information costly, difficult, and time-consuming.

Health care providers commonly operate a closed IT network with firewall technology in place to bridge to the public internet. This closed network topology may present challenges for the electronic exchange of medical record information by greatly restricting the types of information that may flow between systems and the directions of information flow.

Various approaches have been taken to protecting the confidentiality of the medical record information, including virtual private networks (VPN's), demilitarized zone (DMZ) border networks, and honest broker mythologies. Each approach, however, may have limitations which may limit the use of the system for general medical record exchange. For example, DMZ networks and associated proxy services limit the directionality of information flow, while VPNs require significant overhead in setup and limit the flexibility of information exchange.

The obligations to protect the privacy of medical record information were substantially enhanced by the passage of the Health Insurance Portability and Accountability Act (HIPAA). However, complying with the numerous requirements of this act using one of the systems described above can be challenging. For example, information can be provided between different health care providers only if the patient has authorized the release of that information, and the receiver of that information is engaged in the treatment of that patient.

### SUMMARY

A health care information provider system may provide information about health care objects managed by a health care provider.

A name generating system may generate an object name for each of the health care objects.

The object name of each health care object may include provider information indicative of the identity of the health care provider which manages the health care object. The provider information may include information indicative of the National Provider ID of the health care provider.

The object name of each health care object may include object information indicative of the identity of the health care object. The object information may not contain any personal health information. The object information may be randomly generated. The object information may include information enabling the integrity of the object information to be verified.

A name delivery system may deliver the object names generated by the name generating system.

An object resolution system may receive object information indicative of the identity of each health care object and provide information about the health care object in response. The object resolution system may include location information correlating the object information for each object to information indicative of the location of the information about each health care object within the health care provider.

A communication system may receive the object information from a health care information access system and, in response, provide the information about the health care object, named in part with the object information, to the health care information access system.

The health care information provider system may include a security system configured to limit access to the information about the health care objects to only authorized heath care information access systems.

At least one of the health care objects may include a health care record, the name of a health care patient, and/or a health care patient study.

The name generating system and the object resolution system may both be under the control of a common health care provider.

A health care information access system may access information about health care objects that are each managed by a health care provider. The health care information access system may include a user interface configured to receive an object name for each of the health care objects. The object name of each health care object may include provider information and object information.

The health care information access system may include a provider identification system configured to identify the health care provider that manages each health care object based on the provider information in the object name of the health care object. The provider identification system may be configured to identify the health care provider that manages each health care object based on a National Provider ID in the provider information.

The health care information access system may include a communication system that provides the object information for each health care object to a health care information provider system controlled by the health care provider managing the health care object. The communication system may receive information about the health care object from the health care information provider system in response.

The health care information access system may include a security system configured to provide each health care information provider system with information identifying the health care information access system. This may enable the health care information provider system to verify the authority of the health care information access system to obtain the information about the health care object managed by each health care information provider system.

A computer system appliance may protect the privacy of medical record information stored in a computer information storage system. This appliance consists of a combination of operating system and application software executing on a hardware platform. The platform may be a general purpose computer, a computer whose sole purpose is to execute the appliance, or a virtualized hardware environment. The appliance may include a medical record distribution compartment, a medical record acquisition compartment, and a security compartment. Compartments provide mechanisms for the assured isolation of information with well defined methods for moving information between compartments. Compartments may be logical concepts, implemented via software mechanisms, such as those found on secure operating systems and database services, or may be physically separate devices.

The medical record distribution compartment may include computer hardware and software configured to receive a request for medical record information from an external computer system, send a request for the medical record information requested by the external computer system only to a security compartment, receive medical record information from only the security compartment in response to the request sent to the security compartment, and send the medical information received from the security compartment only to the external computer system.

The medical record acquisition compartment may include computer hardware and software configured to receive a request for medical record information from only the security compartment, send a request for the medical record information requested by the security department to the computer information storage system, receive medical record information from the computer information storage system in response to the request sent to the computer information storage system, and send the medical record information received from the computer information storage system only to the security compartment.

The security compartment may include computer hardware and software configured to receive a request for medical record information from only the medical record distribution compartment, determine if the request for medical record information received from the medical record distribution compartment satisfies at least a first data policy, and send a request for the medical record information requested by the medical record distribution compartment to only the medical record acquisition compartment if and only if the request for medical record information received from the medical record distribution compartment satisfies the at least first data policy. Configuration is achieved by having the deployed of the appliance specify which entities may or may not send requests to have data transferred to the security compartment, and under what conditions.

The first data policy may be based on a HIPAA regulation. The first data policy may restrict requests for medical record information to only external computer systems that are on an authorized list.

The security compartment may be configured to receive medical record information from only the medical record acquisition compartment in response to the request sent to the medical record acquisition compartment, determine if the medical record information received from the medical record acquisition compartment satisfies at least a second data policy; and send the medical record information received from the medical record acquisition compartment to only the medical record distribution compartment if and only if the medical record information received from the medical record acquisition compartment satisfies the at least second data policy.

The second data policy may be based on a HIPAA regulation. The second data policy may restrict sending of medical record information to medical information which has been authorized to be sent to the external computer system by a patient about whom the medical record information concerns and/or by someone other than a patient about whom the medical record information concerns.

The external computer system may be part of a wide area network. The wide area network may include the internet.

The computer information storage system may be part of a local area network. The computer information storage system may be managed by a hospital.

The computer system appliance may be configured to function as a gateway between the external computer system and the computer information storage system.

The medical record information may include protected health information as defined under HIPAA regulations.

The medical record information may include de-identified data as defined under HIPAA regulations.

The first and/or the second data policy may distinguish between medical record information that is protected health information and that is de-identified data, as both defined under HIPAA regulations.

The security compartment may include a database of security data, including data identifying which external computer systems are authorized to request medical information and/or data identifying which persons are authorized to authorize medical record information to be sent to an external computer system.

The medical record distribution compartment, the medical record acquisition compartment, and the security compartment may include an operating system. The operating system may be configured to permit the medical record distribution compartment and the medical record acquisition compartment to communicate with one another only thought the security compartment.

The computer information storage system may be configured to send medical record information to an external computer system only though the computer system appliance.

The external computer system may be configured to send requests for medical record information stored on the computer information storage system only through the computer system appliance.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details which may be apparent or unnecessary may be omitted to save space or for more effective illustration. Conversely, some embodiments may be practiced without all of the details which are disclosed. When the same numeral appears in different drawings, it refers to the same or like components or steps.

FIG. 1 is an example of a health care information system.

FIG. 2 is an example of a health care information provider system.

FIG. 3 are examples of object names for health care objects.

FIG. 4 is an example of a health care information access system.

FIG. 5 illustrates multiple computer systems interconnected in a manner that protects the privacy of medical record information.

FIG. 6 illustrates an example of a computer system appliance.

### DETAILED DESCRIPTION OF ILLUSTRATIVE EMBODIMENTS

Illustrative embodiments are now discussed. Other embodiments may be used in addition or instead. Details which may be apparent or unnecessary may be omitted to save space or for a more effective presentation. Conversely, some embodiments may be practiced without all of the details which are disclosed.

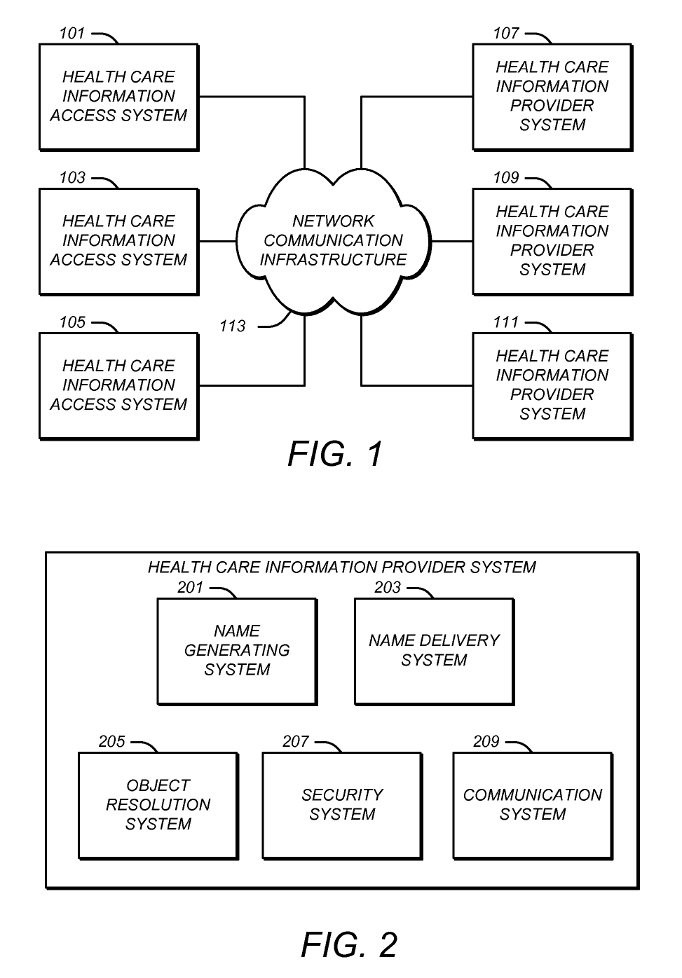

FIG. 1 is an example of a health care information system. The health care information system may include one or more health care information access systems, such as health care information access systems 101, 103, and 105. It may also include one or more health care information provider systems, such as health care information provider systems 107, 109, and 111. It may also include a network communication infrastructure, such as network communication infrastructure 113.

Each health care information access system may be configured to access information about health care objects. These objects may include patient medical records, names and other information about health care patients, and/or health care studies.

Each health care information provider system may be configured to provide information about one or more health care objects. These objects may include patient medical records, names and other information about health care patients, and/or health care studies.

The network communication infrastructure may be configured to facilitate communication of requests for health care information from the health care information access systems to the health care information provider systems. The requests may seek information about and/or copies of one or more health care objects. An example is a request for a copy of a medical imaging study. These health care objects may contain private health information, as commonly defined by federal and local laws. The requests may come from a variety of different types of health care providers, such as hospital, doctor offices, clinics, and/or midwives.

The network communication infrastructure may be configured to communicate responses to those requests from the health care information provider systems to the health care information access systems. The network communication infrastructure may include the internet, wide area networks, local area networks, virtual private networks, gateways, and/or any other type of network communication system or subsystem. The network communication infrastructure need not be specialized for this application, although firewalls and other standard network security services may be included.

FIG. 2 is an example of a health care information provider system.

The health care information provider system illustrated in FIG. 2 may be used as one or more of the health care information provider systems illustrated in FIG. 1. Conversely, one or more of the health care information provider systems illustrated in FIG. 1 may be of a type that is different from the health care information provider system illustrated in FIG. 2.

The health care information provider system illustrated in FIG. 2 may include a name generating system 201, a name delivery system 203, an object resolution system 205, a security system 207, and/or a communication system 209. The health care identification provider system may include additional components not illustrated in FIG. 2. Examples include databases, local authentication systems, and other software components and services.

The name generating system 201 may be configured to generate an object name for each of the health care objects.

Each object name may include provider information and object information.

The provider information may be indicative of the identity of the health care provider that manages the health care object which has been named. The provider information may include information indicative of the National Provider ID of the health care provider. The National Provider ID is administered by the Department of Health and Human Services. Names are prefixed with a field that identifies the name as being a health object identifier. This is followed by “USNPI” which uniquely identifies all providers in the United States. The National Provider ID may include a numeric suffix identifying the particular hospital. In other countries, administered provider namespaces may be used in place of the national provider ID without loss of functionality.

Other information may be included, such as handle attributes in accordance with an object naming convention, such as the one described in U.S. Pat. No. 6,135,646 to Kahn et al., the entire of which is incorporated herein by reference. The attributes may include information such as the hospital name and authentication information which may be used by administrators managing the hospital name space. Through the use of this provider information naming convention, changes in provider names may not necessarily require any change in the provider information which forms part of the object name.

The object information portion of each object name may be indicative of the identity of the health care object. However, the object information may not contain any personal health information. For example, the object information may not include the name of the patient, the address of the patient, the age of the patient, the sex of the patient, or any other information about the identity of the individual about whom the information pertains. Nor may the object information include any such personal health information in any encrypted form which might be subject to decryption through the use of a decryption key.

To facilitate the identification of health care objects devoid of any personal health information, the object information may be randomly generated. For example, the object information may be a randomly-generated number.

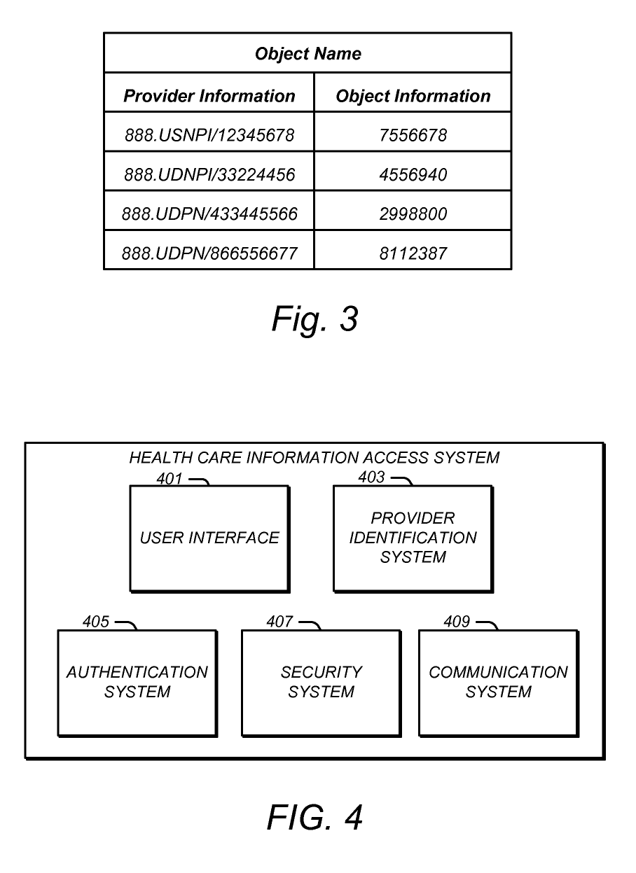

Because the object information may be randomly be generated, it may inherently lack any personal health information which can be extracted with the use of a decryption key. The name generating system 201 may be configured to generate such random numbers, all in accordance with known techniques. FIG. 3 sets forth examples of such random numbers and is discussed in more detail below.

The name generating system 201 may be configured to include information enabling the integrity of the object information, the provider information, or both, to be verified. For example, the name generating system 201 may calculate a check sum for any or all of these fields of information and may include that check sum as part of the object name. Standard cryptographic check sums such as SHA may be used.

The name delivery system 203 may be configured to deliver the object names generated by and delivered from the name generating system 201. Because the object name may be structured so as not to divulge private health information, any standard network delivery protocol may be used to deliver the name. In addition, because the object naming and resolution is decoupled from the access to the object, the configurations of who to deliver to, how, and when may be adjusted to conform to the information sharing workflow. The name delivery system 203 may be configured to deliver these names over the network communication infrastructure illustrated in FIG. 1 via standard network protocols and/or to a user of the health care information provider system through a user interface (not shown), such as a web browser, email client or other specialized application.

The object resolution system 205 may be configured to receive object information indicative of the identity of each health care object. The object resolution system may be configured to provide information about the health care object in response.

The object resolution system 205 may be configured to provide a broad variety of information about each health care object in response. For example, the object resolution system 205 may be configured to provide information about how information about the health care object may be found. This may include, for example, location information correlating the object information for each object to information indicative of the location of the information about each health care object within the health care provider. For example, the object resolution system 205 may be configured to respond to a request for information about a specific health care object by stating where this information currently resides within the health care provider. The object resolution system 205 may be configured to utilize this location information for the purpose of seeking and obtaining the information about the health care object, or may simply return the location information so that the information about the health care object may be accessed by a different system. For example, the name resolution system may return the network address and path (e.g., URL) to one or more storage servers that hold the referenced information (e.g., a patient X-ray), or may provide the application entity title of a DICOM storage device that holds the information (e.g., radiological images). The name resolution system may in addition or instead return a copy of the health care object (e.g., patient X-ray).

The security system 207 may be configured to limit access to the information about the health care objects to only authorized health care information access systems. For example, the security system 207 may request a user name and password from each health care information access system and, before granting access to the requested health care information, verify that the entered user name and password is correct.

The security system 207 may perform further checks to ensure that the querying health care information access system is entitled to receive the requested health care information. For example, the security system 207 may be configured to verify that the requesting health care information access system has a business associates agreement with the institution that is managing the health care object about which information is sought.

The communication system 209 may be configured to receive the object information from a health care information access system. In response, the communication system may be configured to provide the requesting health care information access system with the requested information. The communication system 209 may include such components as a network interface card and related software and hardware systems that facilitate communication between different computers in a network environment.

The name generating system 201 and/or the object resolution system 205 may both be under the control of the health care provider that is managing the requested health care information.

FIG. 3 illustrates examples of object names for health care objects. As illustrated in FIG. 3, each object name may include provider information. The provider information may be indicative of the identity of the health care provider which manages the health care object. As discussed above, the provider information may be in the form of a National Provider ID. As illustrated in FIG. 3, this may take the form of the digits “888,” followed by a decimal, followed by the prefix USNPI, followed by a “/”, and followed finally by a unique handle.

As also illustrated in FIG. 3, each object name may include object information. The object information may be randomly generated, such as a randomly generated number. As explained above, this number may not include any personal health information, even in a form which can be decrypted with a decryption key.

The provider information and object information that forms each object name may be in a form and/or with content that is different from what is illustrated in FIG. 3.

FIG. 4 is an example of a health care information access system.

As illustrated in FIG. 4, the health care information access system may include a user interface 401, a provider identification system 403, an authentication system 405, a security system 407, and a communication system 409.

The user interface 401 may be configured to receive an object name for each of the health care objects from a user of the system. The object name may take any of the forms discussed above in connection with FIGS. 2 and/or 3, or may be in any other form. The user interface may include a keyboard, mouse, touch screen, display, and/or any other type of user interface device. The object names may instead be provided from a different source, such as from a different source connected to the network communication infrastructure.

The provider identification system 403 may be configured to identify the health care provider that manages each health object, based on the provider information in the object name of the health care object. When the provider information includes a National Provider ID, the provider identification system 403 may include a database which associates each national provider ID with an actual provider. The identification of a provider may include a network address or other type of location at which a request for information about a health care object managed by the provider may be sent. When a National Provider ID is not provided, another type of managed name space may be used. The database may include information which associates the provider information in the form in which it is provided with the network addresses or other type of location information for the provider. Any unique name may be used for each provider.

As indicated above, the object information which is received through the user interface 401 may include information enabling the authenticity of the object information to be verified. For this purpose, the authentication system 405 may be configured to verify the authenticity of the object information, based on the information enabling the integrity of the object information to be verified. For example, if the information enabling the authenticity of the object information to be verified includes a check sum, the authentication system 405 may be configured to verify that the addition of all of the bits of the object information is consistent with the check sum.

The security system 407 may be configured to provide each health care information provider system with information identifying the health care information access system. This may enable the health care information provider system to verify the authority of the health care information access system to obtain the information about the health care object that is managed by each health care information provider. For example, the security system 407 may be configured to provide a user name and password to a health care information provider system. The security system 407 may also be configured to verify that it has a business associate's agreement with the institution that is providing the information about the health care object.

The communication system 409 may be configured to deliver the object information to the health care information provider system managed by the health care provider indicated by the provider information. The communication system may be configured to receive information about the health care object from the health care information provider system in response.

The various subsystems which have been described, such as the name generating system 201, the name delivery system 203, the object resolution system 205, the security system 207, the communication system 209, the user interface 401, the provider identification system 403, the authentication system 405, the security system 407, and the communication system 409, may be include computer hardware and software that are configured to perform each of the functions of these subsystems that have been described above, as well as other functions. This computer hardware may include one or more computer processors, support ships, memory storage devices, input/output devices, etc. The software may be stored on one or more of these memory devices.

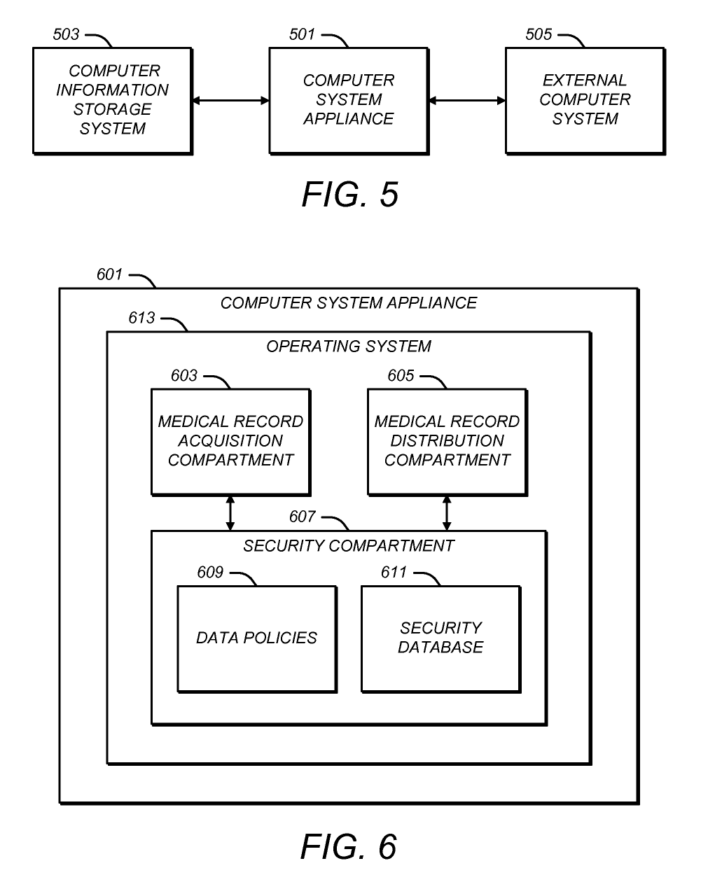

FIG. 5 illustrates multiple computer systems interconnected in a manner that protects the privacy of medical record information.

A computer system appliance 501 may be configured to protect the privacy of medical record information contained within a computer information storage system 503 by arbitrating the delivery of such information to an external computer system 505.

The medical record information may be of any type. For example, the medical record information may include protected health information and/or de-identified data, both as defined under HIPAA regulations. This information may include information needed in connection with the treatment of patients, patient billing information, and/or health care operations (TPO). Examples of such information include images of x-rays, patient bills, physician reports, laboratory results and prescriptions.

The computer information storage system 503 may include one or more computer data storage devices and associated computer hardware and software processing systems. The computer information storage system 503 may be part of a local area network managed by a health care provider, such as by a hospital or a doctor's office. The computer information storage system 503 may include one or more provider information systems, such as one or more EMRs, PACS, databases, and laboratory information systems The computer information storage system 503 may be at a single location or distributed across multiple locations.

The external computer system 505 may be part of a wide area network, which may include the internet. The external computer system 505 may include computer hardware and software configured to request and receive medical record information. The external computer system 505 may be managed by a health care provider, such as by a hospital or a doctor's office.

The computer information storage system 503 may be configured to receive requests for medical record information from the computer system appliance 501 and to supply the requested medical record information to the computer system appliance 501 in response.

Similarly, the external computer system 505 may be configured to request medical record information from the computer system appliance 501 and to receive the requested medical record information in response.

The external computer system 505 may be configured to request medical record information that is stored in the computer information storage system 503 solely by means of sending the request to the computer system appliance 501.

The computer information storage system 503 may be configured to supply requested medical record information to an external computer system solely by supplying that requested medical information to the computer system appliance 501.

In other words, the external computer system 505 and the computer information storage system 503 may both be configured to exchange requests for medical record information and the requested medical record information solely through the computer system appliance 501.

The computer system appliance 501 may be configured to function as a gateway between the external computer system 505 and the computer information storage system 503.

FIG. 6 illustrates an example of a computer system appliance. The computer system appliance illustrated in FIG. 6 may be used as the computer system appliance illustrated in FIG. 5 or in connection with any other type of multiple computer system. The computer system appliance illustrated in FIG. 5 may be different than the computer system appliance 601 illustrated in FIG. 6.

The computer system appliance 601 illustrated in FIG. 6 may be configured to protect the privacy of medical record information stored in a computer information storage system, such as the computer information storage 503 illustrated in FIG. 5. The computer system appliance 601 may include a medical record acquisition compartment 603, a medical record distribution compartment 605, and a security compartment 607 containing data policies 609 and a security database 611.

The medical record acquisition compartment 603, the medical record distribution compartment 605, and the security compartment 607 may include portions of an underlying operating system 613. All of these components may be housed in a single computer.

The medical record distribution compartment 605 may include computer hardware and software. The medical record distribution compartment 605 may be configured to receive a request for medical record information from an external computer system, such as from the external computer system 505 illustrated in FIG. 5. The medical record distribution compartment 605 may be configured to send a request for the medical record information requested by the external computer system only to the security compartment 607. The medical record distribution compartment 605 may be configured to receive medical record information from only the security compartment 607 in response to the request sent to the security department. The medical record distribution compartment 605 may be configured to send the medical information received from the security compartment only to the external computer system.

The medical record acquisition compartment 603 may include computer hardware and software. The medical record acquisition compartment 603 may be configured to receive a request for medical record information from only the security compartment 607. The medical record acquisition compartment may be configured to send a request for the medical record information requested by the security compartment 607 to a computer information storage system containing medical record information, such as to the computer information storage system 503 illustrated in FIG. 5. The medical record acquisition compartment 603 may be configured to receive medical record information from the computer information storage system in response to the request sent to the computer information storage system. The medical record acquisition compartment 603 may be configured to send the medical record information which it receives from the computer information storage system only to the security compartment 607.

The security compartment 607 may include computer hardware and software. The security compartment 607 may be configured to receive a request for medical record information from only the medical record distribution compartment 605. The security compartment 607 may be configured to determine if the request for medical record information received from the medical record distribution compartment 605 satisfies at least a first data policy contained within the data policies 609. The security compartment 607 may be configured to send a request for the medical record information requested by the medical record distribution compartment 605 if and only if the request for medical record information received from the medical record distribution compartment 605 satisfies the at least first data policy contained within the data policies 609.

The first data policy may specify conditions under which request for medical records which are received from the medical record distribution compartment 605 will be sent to the medical record acquisition compartment 603. The first data policy may be based on HIPAA regulations. For example, the first data policy may restrict requests for medical record information to only external computer systems that are on an authorized list. The authorized list may be stored in the security database 611 and/or elsewhere.

The security compartment 607 may be configured to receive medical record information only from the medical record acquisition compartment 603 in response to the request sent to the medical record acquisition compartment 603. The security compartment 607 may be configured to determine if the medical record information received from the medical record acquisition compartment satisfies at least a second data policy contained within the data policies 609. The security compartment 607 may be configured to send the medical record information received from the medical record acquisition compartment 603 to only the medical record distribution compartment 605 if and only if the medical record information received from the medical record acquisition compartment 603 satisfies the at least second data policy.

The second data policy may specify conditions under which medical record information which is received from the medical record acquisition compartment 603 will be sent to the medical record distribution compartment 605. The second data policy may be based on a HIPAA regulation. For example, the second data policy may restrict the sending of medical record information to medical record information which has been authorized to be sent to the external computer system. This authorization may be provided by a patient by filling out an appropriate patient authorization form. This authorization may in addition or instead be provided by medical personnel associated with the medical record information, such as by a physician which has diagnosed or treated the patient.

The first and/or second data policy may distinguish between medical record information that is protected health information and de-identified data, both as defined under HIPAA regulations. Policies are specified by the deployer of the appliance and may be stored in a file, database, or accessed by a policy server by the compartments. Policies may consider the identity of the individual or software compartment publishing or using the data, attributes of the data asserted by the publisher or some other software agent, location of the provider or consumer, along with an extensible set of other conditions.

The security database 611 may contain information which permits the security compartment 607 to perform its security functions. This information may include, for example, a list of persons authorized to authorize the release of medical record information and/or a list of medical record information which patents have authorized to release and to whom. The security database 611 may in addition or instead include information which identifies external computer systems which are authorized to request medical record information.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

For example, the security database 611 and/or the data policies may in whole or in part be separate from the security compartment 607. For example, data policies may be implemented via a policy engine implemented as part of the security compartment, or may be provided by calling out to a separately implemented policy decision point.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications which are set forth in this specification, including in the claims which follow, are approximate, not exact. They are intended to have a reasonable range which is consistent with the functions to which they relate and with what is customary in the art to which they pertain.

All articles, patents, patent applications, and other publications which have been cited in this disclosure are hereby incorporated herein by reference.

The phrase “means for” when used in a claim is intended to and should be interpreted to embrace the corresponding structures and materials which have been described and their equivalents. Similarly, the phrase “step for” when used in a claim is intended to and should be interpreted to embrace the corresponding acts which have been described and their equivalents. The absence of these phrases in a claim mean that the claim is not intended to and should not be interpreted to be limited to any of the corresponding structures, materials, or acts or to their equivalents.

Nothing which has been stated or illustrated is intended or should be interpreted to cause a dedication of any component, step, feature, object, benefit, advantage, or equivalent to the public, regardless of whether it is recited in the claims.

The scope of protection is limited solely by the claims which now follow. That scope is intended and should be interpreted to be as broad as is consistent with the ordinary meaning of the language which is used in the claims when interpreted in light of this specification and the prosecution history which follows and to encompass all structural and functional equivalents.

The invention claimed is:

1. A health care information provider system for providing information about health care objects managed by a health care provider, comprising:
a name generating system configured to generate an object name for each of the health care objects, the object name of each health care object including:
provider information indicative of the identity of the health care provider which manages the health care object;
object information indicative of the identity of the health care object, the object information not containing any personal health information; and
a name delivery system configured to deliver the object names generated by the name generating system; and
an object resolution system configured to receive object information indicative of the identity of each health care object and to provide information about the health care object in response;
a communication system configured to receive the object information from a health care information access system and to provide in response the information about the health care object named in part with the object information to the health care information access system.

2. The health care information provider system of claim 1 wherein the provider information includes information indicative of the National Provider ID of the health care provider.

3. The health care information provider system of claim 1 wherein the object information is randomly generated.

4. The health care information provider system of claim 1 wherein the object resolution system includes location information correlating the object information for each object to information indicative of the location of the information about each health care object within the health care provider.

5. The health care information provider system of claim 1 wherein the object information includes information enabling the integrity of the object information to be verified.

6. The health care information provider system of claim 1 further comprising a security system configured to limit access to the information about the health care objects to only authorized heath care information access systems.

7. The health care information provider system of claim 1 wherein at least one of the health care objects includes a health care record.

8. The health care information provider system of claim 1 wherein at least one of the health care objects includes the name of a health care patient.

9. The health care information provider system of claim 1 wherein at least one of the health care objects includes a health care patient study.

10. The health care information provider system of claim 1 wherein the name generating system and the object resolution system are both under the control of the health care provider.

11. A health care information access system for accessing information about health care objects, each managed by a health care provider, comprising:
a user interface configured to receive an object name for each of the health care objects, the object name of each health care object including:
provider information indicative of the identity of the health care provider which manages the health care object; and
object information indicative of the identity of the health care object, the object information not containing any personal health information;
a provider identification system configured to identify the health care provider that manages each health care object based on the provider information in the object name of the health care object; and
a communication system configured to provide the object information for each health care object to a health care information provider system controlled by the health care provider managing the health care object as determined by the processing system and to receive information about the health care object from the health care information provider system in response.

12. The health care information access system of claim 11 wherein:
the provider information includes information indicative of the National Provider ID of the health care provider; and
the provider identification system is configured to identify the health care provider that manages each health care object based on the National Provider ID in the provider information.

13. The health care information access system of claim 11 wherein the object information is randomly generated.

14. The health care information access system of claim 11 wherein each object name is generated by a name generating system controlled by the health care provider which manages the health care object identified by the object name.

15. The health care information access system of claim 11 wherein the information about each health care object includes information indicative of the location of the information about each health care object within the health care provider.

16. The health care information access system of claim 11 wherein:
the object information includes information enabling the authenticity of the object information to be verified; and
the health care information access system includes an authentication system is configured to verify the authenticity of the object information based on the information enabling the integrity of the object information to be verified.

17. The health care information access system of claim 11 further comprising a security system configured to provide each health care information provider system with information identifying the health care information access system so as to enable the health care information provider system to verify the authority of the health care information access system to obtain the information about the health care object managed by each health care information provider system.

18. The health care information access system of claim 11 wherein at least one of the health care objects includes a health care record.

19. The health care information access system of claim 11 wherein at least one of the health care objects includes the name of a patient.

20. The health care information access system of claim 11 wherein at least one of the health care objects includes a patient study.

21. A computer system appliance for protecting the privacy of medical record information stored in a computer information storage system comprising:
a medical record distribution compartment comprising computer hardware and software configured to:
receive a request for medical record information from an external computer system;
send a request for the medical record information requested by the external computer system only to a security compartment;
receive medical record information from only the security compartment in response to the request sent to the security compartment;
send the medical information received from the security compartment only to the external computer system;
a medical record acquisition compartment comprising computer hardware and software configured to:
receive a request for medical record information from only the security compartment;
send a request for the medical record information requested by the security department to the computer information storage system;
receive medical record information from the computer information storage system in response to the request sent to the computer information storage system;
send the medical record information received from the computer information storage system only to the security compartment;
wherein the security compartment comprises computer hardware and software configured to:
receive a request for medical record information from only the medical record distribution compartment;
determine if the request for medical record information received from the medical record distribution compartment satisfies at least a first data policy;
send a request for the medical record information requested by the medical record distribution compartment to only the medical record acquisition compartment if and only if the request for medical record information received from the medical record distribution compartment satisfies the at least first data policy;
receive medical record information from only the medical record acquisition compartment in response to the request sent to the medical record acquisition compartment;
determine if the medical record information received from the medical record acquisition compartment satisfies at least a second data policy; and
send the medical record information received from the medical record acquisition compartment to only the medical record distribution compartment if and only if the medical record information received from the medical record acquisition compartment satisfies the at least second data policy.

22. The computer system appliance of claim 21 wherein the computer system appliance is configured to function as a gateway between the external computer system and the computer information storage system.

23. The computer system appliance of claim 23 wherein the external computer system is part of a wide area network.

24. The computer system appliance of claim 23 wherein the wide area network includes the internet.

25. The computer system appliance of claim 23 wherein the computer information storage system is part of a local area network.

26. The computer system appliance of claim 25 wherein the computer information storage system is managed by a hospital.

27. The computer system appliance of claim 21 wherein the first data policy is based on a HIPAA regulation.

28. The computer system appliance of claim 27 wherein the first data policy restrict requests for medical record information to only external computer systems that are on an authorized list.

29. The computer system appliance of claim 21 wherein the second data policy is based on a HIPAA regulation.

30. The computer system appliance of claim 29 wherein the second data policy restricts sending of medical record information to medical information which has been authorized to be sent to the external computer system.

31. The computer system appliance of claim 30 wherein the second data policy restricts sending of medical record information to medical record information which has been authorized to be sent to the external computer system by a patient about whom the medical record information concerns.

32. The computer system appliance of claim 30 wherein the second data policy restricts sending of medical record information to medical record information which has been authorized to be sent to the external computer system by someone other than a patient about whom the medical record information concerns.

33. The computer system appliance of claim 21 wherein the medical record information includes protected health information as defined under HIPAA regulations.

34. The computer system appliance of claim 21 wherein the medical record information includes de-identified data as defined under HIPAA regulations.

35. The computer system appliance of claim 21 wherein the first and/or the second data policy distinguished between medical record information that is protected health information or de-identified data, as both defined under HIPAA regulations.

36. The computer system appliance of claim 21 wherein the security compartment includes a database of security data, including data identifying which external computer systems are authorized to request medical information.

37. The computer system appliance of claim 21 wherein the security compartment includes a database of security data, including data identifying which persons are authorized to authorize medical record information to be sent to an external computer system.

38. The computer system of claim 21 wherein the medical record distribution compartment, the medical record acquistion compartment, and the security compartment include an operating system and wherein the operating system is configured to permit the medical record distribution compartment and the medical record distribution compartment to communicate with one another only thought the security compartment.

39. A computer system comprising a computer system appliance of the type recited in claim 21 and a computer information storage system configured to send medical record information to an external computer system only though the computer system appliance.

40. A computer system comprising a computer system appliance of the type recited in claim 21 and an external computer system configured to send requests for medical record information stored on the computer information storage system only through the computer system appliance.
